(19) United States
(12) Patent Application Publication
(10) Pub. No.: US 2009/0322936 A1
(43) Pub. Date: Dec. 31, 2009

(54) AUTO FOCUSING METHOD FOR FACE DETECTION OF DIGITAL IMAGING DEVICE

(75) Inventors: Ming-Jiun Liaw, Miaoli County (TW); Hong-Long Chou, Taipei (TW)

Correspondence Address: APEX JURIS, PLLC, 12733 LAKE CITY WAY NORTHEAST, SEATTLE, WA, 98125, US

(73) Assignee: ALTEK CORPORATION, Hsinchu (TW)

(21) Appl. No.: 12/490,642

(22) Filed: Jun. 24, 2009

(30) Foreign Application Priority Data
Jun. 25, 2008 (TW) 097123811

(51) Int. Cl. H04N 5/232

(52) U.S. Cl. 348/354; 348/E05.045

(57) ABSTRACT

A auto focusing method for face detection of a digital imaging device is described, in which high-frequency information of a focusing area is increased according to a size, a position of a face of a person to be shot, and an image area at least covering the face and body of the person, thereby improving a focusing success ratio.

### CROSS-REFERENCE TO RELATED APPLICATIONS

This non-provisional application claims priority under 35 U.S.C. §119(a) on Patent Application No(s). 097123811 filed in Taiwan, R.O.C. on Jun. 25, 2008 the entire contents of which are hereby incorporated by reference.

### BACKGROUND OF THE INVENTION

1. Field of the Invention

The present invention relates to a auto focusing method, and more particularly to a auto focusing method for face detection of a digital imaging device, in which the face auto focusing process is achieved according to a position, a size, an orientation of a face, and an image area at least covering a body.

2. Related Art

As digital cameras have been developed, photography is no longer an expensive consumption. A user can randomly shoot desired images, for recording memorable moments or sceneries. Generally, during shooting, in order to emphasize the main object, it focuses on the main object. In other words, the focal length is aligned with an object to be shot. Therefore, most of the cameras have an auto focusing function.

With the development of the technique, more and more digital cameras have a face detection function, in which the optimal exposure condition and the optimal focusing distance are determined according to the position of the human face, such that the image quality of the shot portrait is more desirable. In the face auto focusing method of the digital camera, the human face area defined according to results of the human face detection including a size and a position of the human face is taken as a focusing window. FIGS. 1a and 1b are schematic views of human face windows 110a and 120a (dash line frames) and focusing windows 110b and 120b (real line frames). High-frequency signals in the focusing window (i.e., the human face area) are calculated through an auto focusing program, and an optimal focusing position is obtained by using a conventional mountain pass theory or a curve fitting technique.

However, as for the high-frequency signals of the human face area, except the contour line of each organ, generally, the high-frequency messages at the skin covered areas are not distinct. When the shooting environment is slightly dark, the camera may be used under a higher international standards organization (ISO) value. Since a higher ISO value in the digital camera indicates a higher gain value, the higher gain value indicates that the noises may also be amplified, such that the high-frequency signals of the contour lines of the organs on the human face are weaker than the noises, and the high-frequency signals may not be effectively captured by an auto focusing module, and thus, the focusing may not be effectively performed.

Under such a state, if it intends to increase the focusing success ratio, one way is to reduce the noises of the system. For example, the elements or manufacturing process with higher quality are used, or the number of layers of printed circuit boards is increased. However, no matter how to reduce the noises, the noises are still amplified by the higher gain value. What's more, the above solution results in a higher cost. Therefore, it has become an object for many researchers how to improve the auto focusing success ratio of the human face, without increasing the cost.

Another disadvantage of defining the human face window as identical to the focusing window lies in that the tolerance on the human face detection errors is relatively low. FIGS. 2a and 2b are schematic views of human face windows (dash line frames) and focusing windows (real line frames). When an error occurs to the determination of the human face detecting program, and the human face window (a human face window (dash line window) 210a and a human face window (dash line window) 220a) covers the background, since the background usually has abundant high-frequency signals, for example, leaves and flowering shrubs, if the human face window is directly defined as the focusing window (a human face window (focusing window) 210b and a human face window (focusing window) 220b), it may easily result in the mis-determination of the auto focusing program, and the object distance is set at the background for shooting. As a result, a picture with a clear background and a fuzzy portrait is obtained. Therefore, it has also become an object for the researchers how to design an auto focusing program with a relatively high tolerance on the human face detection errors.

### SUMMARY OF THE INVENTION

In view of the above problems, the present invention is mainly directed to an auto focusing method of a digital imaging device, in which when the digital imaging device performs focusing, a focusing area extends along a direction from a human face to a body, and at least covers above a chest, thereby covering high-frequency signals of a collar and decorative patterns of a coat.

In order to achieve the above objective, a face auto focusing method of a digital imaging device is provided in the present invention, which includes the following steps of loading human face size information, human face position information, and orientation information; determining a focusing window according to the human face size, the human face position information, and the orientation information, in which the focusing window is an image area at least covering a human face area and a body; capturing the digital images; calculating high-frequency signals of the focusing window in each digital image; obtaining a maximum value from the high-frequency signals; and moving a focusing lens assembly of the digital imaging device to a lens position of the object distance corresponding to the maximum value, so as to finish the focusing.

### BRIEF DESCRIPTION OF THE DRAWINGS

The present invention will become more fully understood from the detailed description given herein below for illustration only, and thus is not limitative of the present invention, and wherein:

FIG. 1a is a schematic view of a human face window (a dash line frame) and a focusing window (a real line frame) in the conventional art;

FIG. 1b is a schematic view of a human face window (a dash line frame) and a focusing window (a real line frame) in the conventional art;

FIG. 2a is a schematic view of a possible human face window (a dash line frame) and a possible focusing window (a real line frame) when an error occurs to the determination of the human face in the conventional art;

FIG. 2b is a schematic view of a possible human face window (a dash line frame) and a possible focusing window (the real line frame) when an error occurs to the determination of the human face in the conventional art;

FIG. 3 is a schematic view of a structure of a digital imaging device according to the present invention;

FIG. 4a is a schematic view of a human face window (a dash line frame) and a focusing window (a real line frame) according to the present invention;

FIG. 4b is a schematic view of a human face window (a dash line frame) and a focusing window (a real line frame) according to the present invention; and

FIG. 5 is a schematic flow chart of operations according to the present invention.

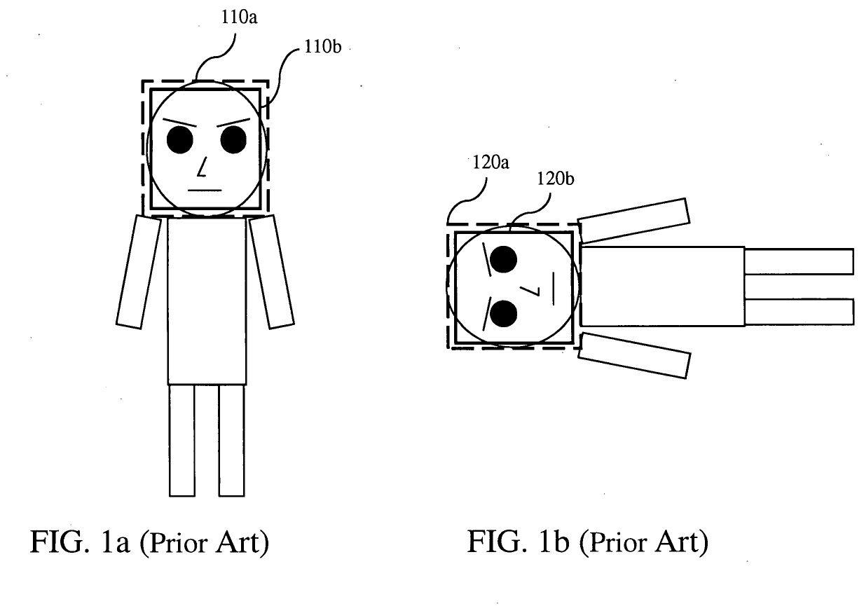

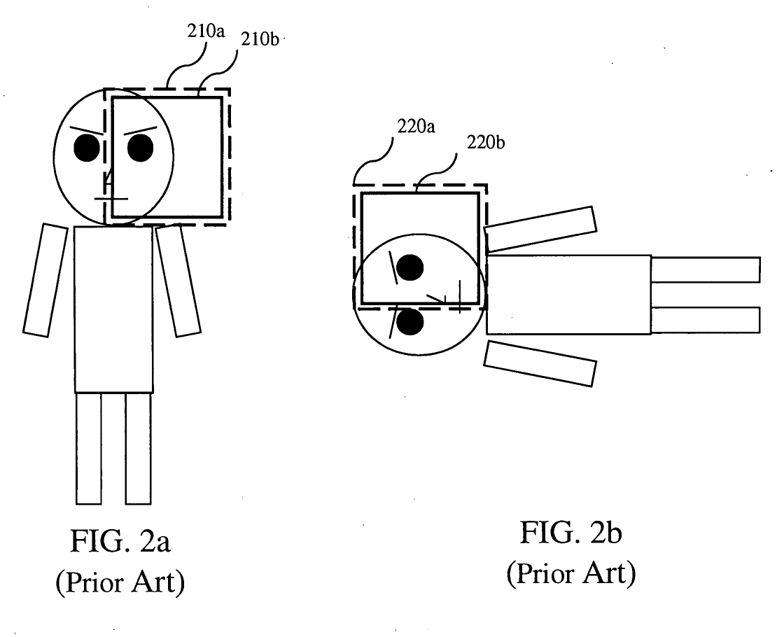

### DETAILED DESCRIPTION OF THE INVENTION

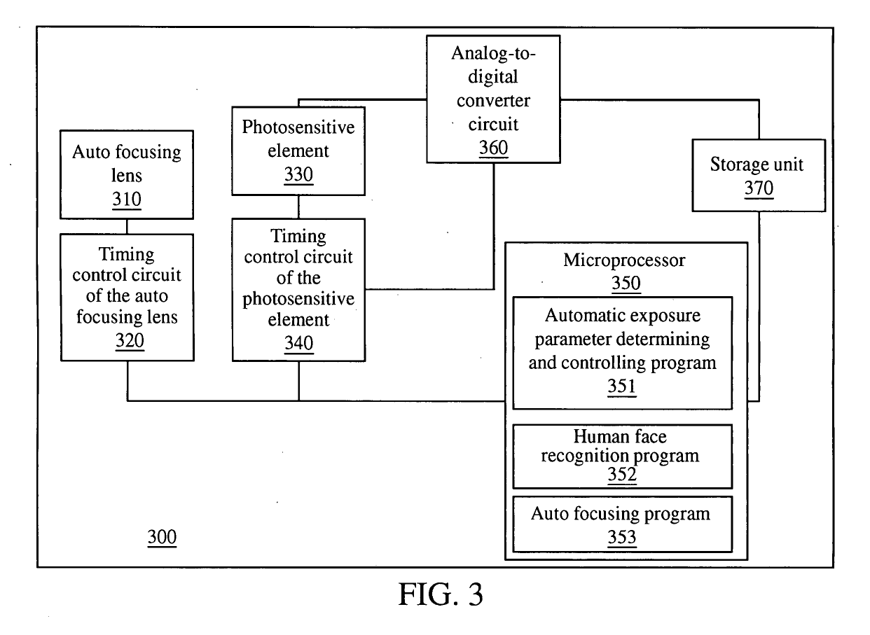

FIG. 3 is a schematic view of a structure of a digital imaging device according to the present invention. Referring to FIG. 3, a digital imaging device 300 of the present invention includes an auto focusing lens 310, a timing control circuit 320 of the auto focusing lens, a photosensitive element 330, a timing control circuit 340 of the photosensitive element, a microprocessor 350, an analog-to-digital converter circuit 360, and a storage unit 370.

The auto focusing lens 310 is electrically connected to the timing control circuit 320 of the auto focusing lens, the timing control circuit 320 of the auto focusing lens controls to move the auto focusing lens 310, and images the shot environment and object on the photosensitive element 330. The timing control circuit 320 of the auto focusing lens is electrically connected to the microprocessor 350, and generates a control signal for driving the auto focusing lens 310 under the instruction of the microprocessor 350. The photosensitive element 330 is a photoelectric conversion element, for recording optical signals of the shot environment and object, and converting the optical signals into electric signals. The photosensitive element 330 may be, for example, a charge-coupled device (CCD) or a complementary metal-oxide-semiconductor (CMOS).

The timing control circuit 340 of the photosensitive element is electrically connected to the photosensitive element 330 and the microprocessor 350, and generates a control signal for driving the photosensitive element 330 under the control of the microprocessor 350. The analog-to-digital converter circuit 360 is electrically connected to the photosensitive element 330, the timing control circuit 340 of the photosensitive element, and the storage unit 370, converts an analog signal transmitted by the photosensitive element 330 into a digital signal under the control of the timing control circuit 340 of the photosensitive element, and transfers the digital signal to the storage unit 370.

The storage unit 370 is electrically connected to the analog-to-digital converter circuit 360 and the microprocessor 350. The storage unit 370 is used to read and write the data under the control of the microprocessor 350. When the face auto focusing is executed, the microprocessor 350 has an automatic exposure parameter determining and controlling program 351, a human face recognition program 352, and an auto focusing program 353, which are provided for the microprocessor 350 to execute a corresponding function program. An automatic exposure parameter determining and controlling module determines appropriate exposure parameters including an exposure time, an aperture size, and an ISO value according to the shooting environment.

The microprocessor 350 is electrically connected to the timing control circuit 320 of the auto focusing lens, the timing control circuit 340 of the photosensitive element, and the storage unit 370. The microprocessor 350 transfers various parameters generated by the automatic exposure parameter determining and controlling program 351 to the timing control circuit 320 of the auto focusing lens, the timing control circuit 340 of the photosensitive element, and the analog-to-digital converter circuit 360, for shooting the image. The human face recognition program 352 finds out an area satisfying the characteristics of the human face from the pre-shot digital images, and records the human face position, the human face size, and the rotating orientation.

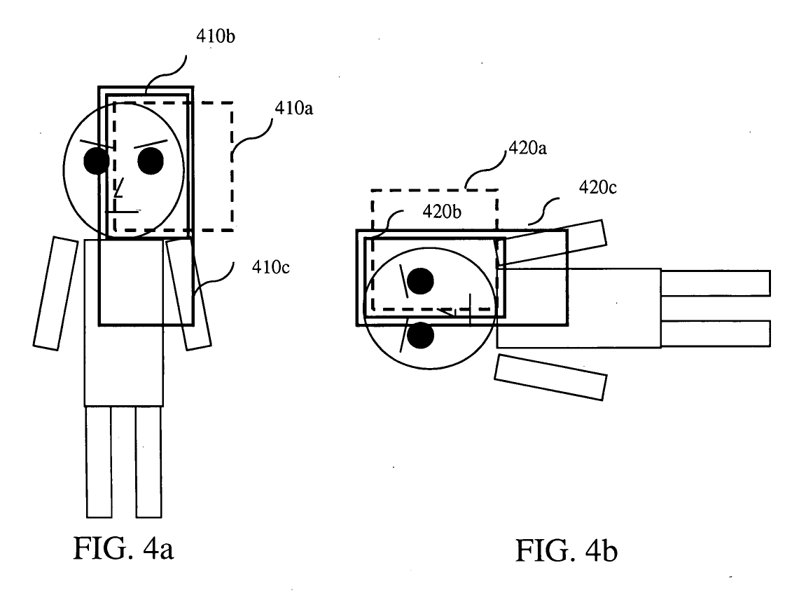

The auto focusing program 353 circles the human face in the digital image by using the human face window, according to the information generated by the human face recognition program 352. FIGS. 4a and 4b are respectively schematic views of human face window areas and focusing windows. Referring to FIGS. 4a and 4b, the auto focusing program 353 searches for a position of the skin color area (for example, a recognition window 410b of FIG. 4a and a recognition window 420b of FIG. 4b) in the human face window area (for example, a human face window 410a of FIG. 4a and a human face window 420a of FIG. 4b show the positions of the human face windows provided when an error occurs to the recognition of the human face recognition program 352), extends the area along the direction of the body into an image area at least covering the body (a body window 410c of FIG. 4a and a body window 420c of FIG. 4b), which is defined as a focusing window. The auto focusing program 353 obtains the relation between the high-frequency signals and the object distance in the focusing window, determines an object distance corresponding to the maximum value of the high-frequency signals, and moves the focusing lens assembly to the position, so as to finish the focusing process. The manner of calculating the high-frequency signals in the focusing window may include, but not limited to, a high-pass filter, a band-pass filter, a Fourier transformation, a discrete cosine transformation, or a discrete wavelet transformation.

In practice, once the user presses a shooting key to take a picture, the automatic exposure parameter determining and controlling program 351 in the microprocessor 350 determines exposure parameters required by shooting and exposure parameters required by auto focusing according to the environment at that time. Meanwhile, the human face recognition program 352 in the microprocessor 350 detects the position, the size, and the orientation of the human face, and transmits the information to the auto focusing program 353. The orientation information of the human face refers to an included angle between a human face angle in the human face area and a horizontal line or a vertical line in each digital image. The orientation information may be provided by a face detection module or a rotation sensor.

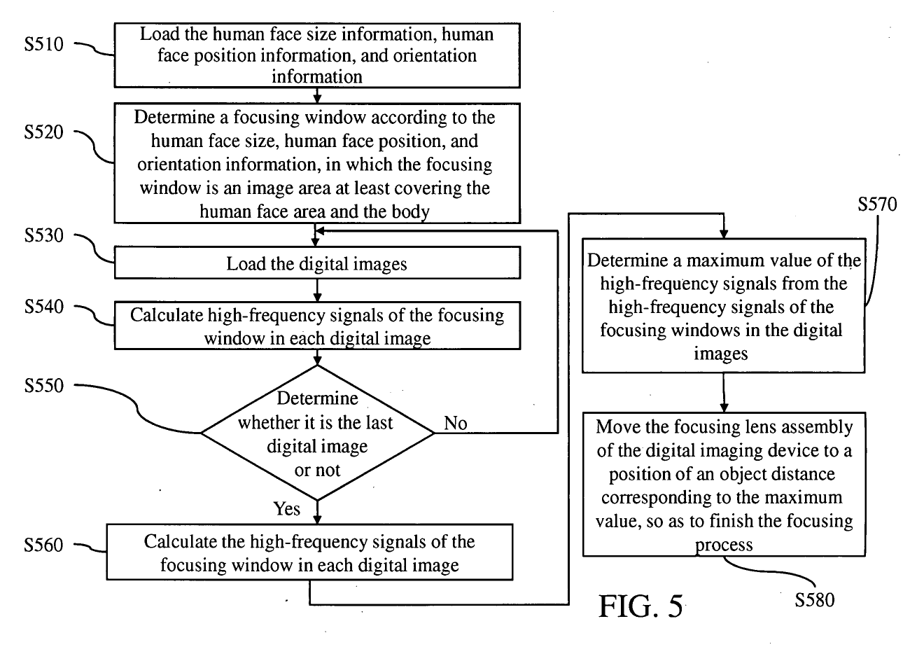

FIG. 5 is schematic flow chart of operations according to the present invention. Referring to FIG. 5, human face size information, human face position information, and orientation information are loaded (Step S510). According to the human face size, human face position, and orientation information, a focusing window is determined, in which the focusing window is an image area at least covering the human face area and the body (Step S520). The digital images are loaded (Step S530). The high-frequency signals of the focusing window in each digital image are calculated (Step S540), and transferred to the microprocessor.

It is determined whether it is the last digital image or not (Step S550). The high-frequency signals of the focusing window in each digital image are calculated (Step S560). Then, a maximum value of the high-frequency signals is determined from the high-frequency signals of the focusing windows in the digital images (Step S570). The focusing lens assembly of the digital imaging device is moved to a position of an object distance corresponding to the maximum value, so as to finish the focusing process (Step S580).

What is claimed is:

1. A auto focusing method for face detection of a digital imaging device, applicable for determining a focusing distance of the digital imaging device according to at least one human face size information, human face position information, and orientation information captured by the digital imaging device during pre-shooting and a plurality of digital images captured at different object distances, the method comprising:
loading the human face size information, human face position information, and orientation information;
determining a focusing window according to the human face size, human face position information, and orientation information, wherein the focusing window is an image area at least covering a human face area and a body;
capturing the digital images;
calculating high-frequency signals of the focusing window in each digital image;
obtaining a maximum value of the high-frequency signals; and
moving a focusing lens assembly of the digital imaging device to a lens position of an object distance corresponding to the maximum value, so as to finish the focusing process.

2. The auto focusing method for face detection of a digital imaging device according to claim 1, wherein the orientation information of the human face refers to an included angle between a human face angle in the human face area and a horizontal line or a vertical line in each digital image.

3. The auto focusing method for face detection of a digital imaging device according to claim 2, wherein the orientation information is provided by a face detection module or a rotation sensor.

4. The auto focusing method for face detection of a digital imaging device according to claim 1, wherein the focusing window is determined with reference to the orientation information and the focusing window is obtained by extending the human face area along a direction of the body to at least cover above a chest of the body.

5. The auto focusing method for face detection of a digital imaging device according to claim 1, wherein the focusing window is determined through determining a skin color area once again according to a color of the human face area, and the focusing window is obtained by extending the area along a direction of the body to at least cover above a chest of the body.
